(19) United States
(12) Patent Application Publication
(10) Pub. No.: US 2024/0040043 A1
(43) Pub. Date: Feb. 1, 2024

(54) ACOUSTIC FEEDBACK MANAGEMENT IN REAL-TIME AUDIO COMMUNICATION

(71) Applicant: Dolby Laboratories Licensing Corporation, San Francisco, CA (US)

(72) Inventors: Qianqian FANG, Beijing (CN); Kai LI, Beijing (CN); Yanmeng GUO, Beijing (CN); Wei HUANG, Beijing (CN); Yang LIU, Beijing (CN)

(73) Assignee: Dolby Laboratories Licensing Corporation, San Francisco, CA (US)

(21) Appl. No.: 18/258,302

(22) PCT Filed: Dec. 22, 2021
(86) PCT No.: PCT/US2021/064883

§ 371 Date: Jun. 19, 2023

Related U.S. Application Data
(60) Provisional application No. 63/142,018, filed on Jan. 27, 2021.

(30) Foreign Application Priority Data
Dec. 22, 2020 (WO) PCT/CN2020/138271
Feb. 2, 2021 (EP) 21154740.1

(51) Int. Cl. H04M 9/08; H04M 3/40; H04R 3/02

(52) U.S. Cl. CPC H04M 9/08; H04M 3/40; H04R 3/02

(57) ABSTRACT

Disclosed is a method for managing acoustic feedback in real-time audio communications in a communications system, the method comprising determining, by means of a detection module, whether a first communication device is in loudspeaker mode, whether the first communication device is in real-time audio communications with a second communication, and whether the first communication device and the second communication device are in a same acoustic space. Upon determining that this is the case a request signal for requesting one or more measures against acoustic feedback is provided to a mitigation module. Further disclosed are a device and a system configured to perform the method, a non-transitory computer-readable medium, an encoder and a decoder.

### CROSS-REFERENCE TO RELATED APPLICATION

This application claims priority of the following priority applications: EP application 21154740.1, filed 2 Feb. 2021, PCT application PCT/CN2020/138271, filed 22 Dec. 2020 and U.S. provisional application 63/142,018, filed 27 Jan. 2021.

### TECHNICAL FIELD

The present disclosure relates to managing acoustic feedback in real-time audio communication.

### BACKGROUND

In multiparty communications including real-time audio communication, such as in multiparty conferences and multiparty games, audio feedback, also known as howl, may occur. Such audio feedback is typically disturbing to the parties participating the multiparty communications and hence measures to remove or mitigate it has been provided using analysis of acoustic features audio signals in the multiparty communications in order to identify occurrence of audio feedback and then remove or mitigate the audio feedback.

### SUMMARY

An object of the present disclosure is to provide an improved managing of acoustic feedback.

According to a first aspect of the present disclosure, there is provided a method for managing acoustic feedback in real-time audio communications in a communications system. The method comprises: determining, by means of a detection module, whether a first communication device is in loudspeaker mode based on hardware information in the first communication device; determining, by means of the detection module, whether the first communication device is in real-time audio communications with a second communication device based on connection information in the first communication device; determining, by means of the detection module, whether the first communication device and the second communication device are in a same acoustic space based on sensor information in the first communication device; upon determining by means of the detection module that:
the first communication device is in loudspeaker mode,
the first communication device is in real-time audio communications with the second communication device, and
the first communication device and the second communication device are in the same acoustic space,
   providing, to a mitigation module, a request signal for requesting one or more measures against acoustic feedback.

By identifying that the three criteria are met that the first communication device is in loudspeaker mode, that the first communication device is in real-time audio communications with the second communication device, and that the first communication device and the second communication device are in the same acoustic space, a risk that acoustic feedback may occur is identified. As the criteria being met can be identified even before any sound has been feedback via the first communication device, the risk for acoustic feedback may be identified even before any acoustic feedback has occurred.

According to a second aspect of the present disclosure, a communication device is provided comprising circuitry configured to perform the method according to the first aspect.

According to a third aspect of the present disclosure, a communications system comprising a first communication device, a second communication device, a detection module, and a mitigation module is provided. The system is configured to perform the method according to the first aspect.

According to a fourth aspect of the present disclosure, a non-transitory computer-readable storage medium is provided comprising instructions which, when executed by a device having processing capability, causes the device to carry out the method of the first aspect.

According to a fifth aspect of the present disclosure, an encoder is provided. The encoder is configured to encode an audio signal, and include, in the encoded audio signal, metadata indicating whether there is a need for one or more measures against acoustic feedback.

By including, in the encoded audio signal, metadata indicating whether there is a need for one or more measures against acoustic feedback, a receiver of the encoded audio signal may be provided with information on whether there is a need for one or more measures against acoustic feedback even if the receiver of the encoded audio signal does not include any functionality for identification of such a need itself.

According to a sixth aspect of the present disclosure, a decoder is provided. The decoder is configured to decode an encoded audio signal, and extract, from the decoded audio signal, metadata indicating whether there is a need for measures against acoustic feedback.

By configuring the decoder to extract, from the decoded audio signal, metadata indicating whether there is a need for measures against acoustic feedback, a decoder at a receiver of the encoded audio signal may identify on whether there is a need for one or more measures against acoustic feedback even if the receiver of the encoded audio signal does not include any functionality for identification of such a need itself.

### BRIEF DESCRIPTION OF THE DRAWINGS

Embodiments of the present disclosure will be described in more detail with reference to the appended drawings, wherein

FIG. 1 shows a flow chart of an embodiment of a method for managing acoustic feedback in real-time audio communications according to the present disclosure,

FIG. 2a shows a schematic block diagram of a first embodiment of a communications system configured to perform a method according to the present disclosure,

FIG. 2b shows a schematic block diagram of a second embodiment of a communications system configured to perform a method according to the present disclosure,

FIG. 2c shows a schematic block diagram of a third embodiment of a communications system configured to perform a method according to the present disclosure,

FIG. 3 shows a schematic block diagram of a communication device comprising circuitry configured to perform a method according to the present disclosure,

FIG. 4 shows a schematic block diagram of an encoder according to the present disclosure,

FIG. 5 shows a schematic block diagram of a decoder according to the present disclosure.

### DETAILED DESCRIPTION

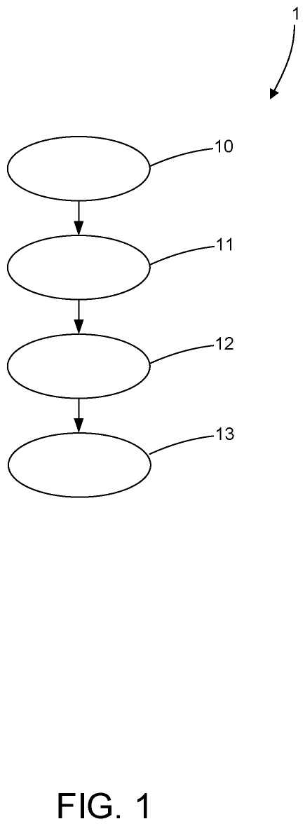

FIG. 1 shows a flow chart of an embodiment of a method 1 for managing acoustic feedback in real-time audio communications in a communications system.

By real-time audio communications may here be understood any audio transmission between two or more communication devices occurring real-time, i.e. live, including audio an audio call, a video call with audio, a conference call, or the like. Real-time in this should be construed as a continuous audio data transmission performed in real-time or approximately real-time, such as a voice call or the like, where it is intended that audio reaches the receiver with as short timely delay as possible without influencing the intelligibility of the audio.

In some embodiments, the communications system comprises the first client, the second client, and a communications server, wherein one or more of the detection module and the mitigation module is provided in the communications server.

The method 1 comprises determining 10, by means of a detection module, whether a first communication device is in loudspeaker mode based on hardware information in the first communication device.

The first communications device may be a phone, such as a cellular phone, a mobile phone, and/or a conference phone, a computer, a tablet computer, or the like. A loudspeaker mode may be a mode, in which the first communications device is configured to output sound, such as sound from the real-time audio communications, via one or more loudspeakers, such as one or more built-in loudspeakers.

In some embodiments, the first communications device may be in the loudspeaker mode, in a headphone mode, in which mode the first communications device is configured to output sound via headphones, or may be in a muted mode, in which the first communications device is configured not to output sound. The step of determining 10 may alternatively or additionally comprise determining a mode of the first communication device, the mode being selected from a loudspeaker mode, a headphone mode, and a muted mode based on hardware information in the first communication device.

Hardware information in the first communication device may comprise information relating to one or more of a status of a headphone output connection, such as whether a plug is inserted in a headphone output plug, whether headphones are communicatively connected wired and/or wirelessly, whether one or more loudspeakers, such as built-in loudspeakers and/or external loudspeakers, are communicatively connected to the first communication device, a default playback device, and a playback device selected for the real-time audio communication. In some embodiments, the method may further comprise obtaining from the first communication device and/or from the second communication device information regarding the type of communication device, such as identification information of the communication device. The identification information may allow the type of communication device to be determined, such as smartphone, tablet computer, conference device, laptop computer, desktop computer, or the like. Alternatively or additionally, the identification information may allow the manufacturer, version, Operating System (OS), OS version, hardware revision or the like, to be determined. In some embodiments the identification information may be obtained directly from the first and/or second communication device.

The detection module may be provided in the first communication device. Alternatively or additionally, where the real-time audio communication is provided via a server, the detection module may be provided in the server. Hence, the hardware information may be transmitted from the first communication device to the server.

In some embodiments, one or more of the detection module and the mitigation module is provided in the first device.

The method 1 moreover comprises determining 11, by means of the detection module, whether the first communication device is in real-time audio communications with a second communication device based on connection information in the first communication device.

Determining 11 whether the first communication device is in real-time audio communication with a second communication device may be carried out via software information from a communication module of the first device, data transmitted from the second device, and/or via a server, potentially through which real-time audio communication is controlled and/or routed.

The method 1 further comprises determining 12, by means of the detection module, whether the first communication device and the second communication device are in a same acoustic space based on sensor information in the first communication device.

By two devices being in the same “acoustic space” may here be understood that the two devices are in the same physical space and/or room and/or that the two devices are within a certain distance of each other. Alternatively or additionally the two devices may be said to be in the same “acoustic space” when an acoustic power loss of sound from the first device when reaching the second device and/or vice versa is less than a predefined threshold value.

The sensor information may be based on a non-acoustic sensor of the first communication device. Alternatively or additionally, the sensor information may be based on data transmission between the first and the second device.

In some embodiments, the sensor information of the first device is based on a wireless communication interface of the first device.

The wireless communication interface of the first device may be a wireless communication interface for digital data communication. The wireless communication interface may comprise a transmitter, potentially configured to transmit a wireless communication signal, and a receiver, potentially configured to receive a wireless communication signal. The wireless communication interface may be configured for short-range wireless communication, such as communication in a 2.4 GHz frequency band, in a 5 GHz frequency band, and/or in a 6 GHz frequency band.

The wireless communication interface may comprise or be a Bluetooth® interface, such as a Bluetooth® Low Energy (LE) interface. Alternatively or additionally, the wireless communication interface may comprise or be a Wi-Fi wireless network interface, potentially configured to function in accordance with an IEEE 802.11 standard.

In some embodiments, both the first and the second devices comprise a wireless communication interface. Determining 12 whether the first and second devices are in the same acoustic space may be based on sensor information of both the first and second devices.

In some embodiments, the method further comprises determining, by means of the detection module, a distance between the first communication device and the second communication device based on sensor information in the first communication device. The first communication device and the second communication device are determined to be in the same acoustic space if the distance between the first communication device and the second communication device is less than a distance threshold.

The determined distance may be an estimated distance. For instance, where the sensor information comprises information from a wireless communication interface, the distance may be estimated based on received signals.

The distance threshold may be predetermined. In some embodiments, the distance threshold is 10 m or less, such as 8 m, 6 m, 5 m, 4 m, 3 m, 2 m, or 1 m.

In one embodiment, potentially where the wireless communication interface comprises a Bluetooth® interface, the distance is determined based on a Received Signal Strength Indication (RSSI) measurement of the signal received at the first communication device from the second communication device. Where Bluetooth LE is used, the signal received at the first communication device may be a connection packet, such as a connection request packet, a connection response packet, a data packet, and/or an advertisement packet from the second communication device. The relationship between the RSSI and the distance may be described as:

RSSI_{dBm}=−10n log₁₀(d)+A(l)
where d is the distance, n is a real number between two and four depending on environment conditions and A(l) is a RSSI value read at an arbitrarily selected distance.

Hence, the distance may be determined from the RSSI as:

$$d = {10}^{\frac{A ( l ) - {RSSI}_{dBm}}{10 n}}$$

Thereby an estimated distance may be determined based on the received signal strength.

Alternatively or additionally, the distance may, potentially where the wireless communication interface comprises a Wi-Fi interface, be determined based on a round-trip time (RTT). The first communication device may determine the distance using a Wi-Fi access point. Additionally or alternatively, the first communication device may peer the second communication device, which may be a Wi-Fi Aware device. The determined distance may be an estimated distance. The RTT may be determined in accordance with a standard under IEEE 802.11.

The method 1 further comprises, upon determining by means of the detection module that: the first communication device is in loudspeaker mode, the first communication device is in real-time audio communications with the second communication device, and the first communication device and the second communication device are in the same acoustic space, providing 13, to a mitigation module, a request signal for requesting one or more measures against acoustic feedback.

The mitigation module may be a module configured to mitigate feedback. The mitigation module may be arranged in the first communication device, in the second communication device, and/or in a server, via which the real-time audio communication may be routed.

The request signal may be provided as metadata to audio data of the real-time audio communication. The request signal may be provided from the first communication device and/or, where a server, via which the real-time audio communication is routed, is provided, from the server. The request signal may alternatively be provided as a separate signal, potentially via the same connection. The request signal may comprise an indication, such as a flag, a binary value, a hexadecimal value, a text string, or the like, that one or more measures against acoustic feedback is desired and/or needed. Alternatively or additionally, the request signal may comprise an indication that it has been determined that the first communication device is in loudspeaker mode, the first communication device is in real-time audio communications with the second communication device, and the first communication device and the second communication device are in the same acoustic space.

The request signal may be provided where no acoustic feedback has occurred but where the conditions for an occurrence of acoustic feedback have been met.

In some embodiments, the method further comprises upon determining by means of the detection module that: the first communication device is in loudspeaker mode, the first communication device is in real-time audio communications with the second communication device, and the first communication device and the second communication device are in the same acoustic space, determining, by means of the detection module, a state in the first communication device indicating a need for measures against acoustic feedback.

The state may indicate that acoustic feedback occurs and/or is likely to occur. In some embodiments, the state in the first communication device may represent a state of the communication system. The request signal may comprise or consist of the state. Alternatively or additionally, the request signal may be provided in response to determining the state in the first communication device.

Where measures against acoustic feedback are taken, the state in the first communication device may be determined as a state indicating no need for measures, or further measures, against acoustic feedback. Alternatively, where measures against acoustic feedback have been taken, determining steps 10, 11, and 12 may be performed again subsequent to the measures being taken, and, where it is determined that the first communication device is in loudspeaker mode, the first communication device is in real-time audio communications with the second communication device, and the first communication device and the second communication device are in the same acoustic space, the state in the first communication device indicating a need for measures against acoustic feedback may be determined again and/or may be maintained.

In some embodiments, the method further comprises providing, by the mitigation module, one or more measures against acoustic feedback in response to receiving, at the mitigation module, the request signal.

In some embodiments, the one or more measures against acoustic feedback include one or more of: decreasing, by means of the mitigation module, a playback volume of the first communication device, decreasing, by means of the mitigation module, a microphone gain of the second communication device, sending a notification to the first communication device requesting a user to switch to headphone mode, sending a notification to the first communication device requesting the user to mute a microphone of the first communication device, sending a notification to the first communication device requesting the user to mute a loudspeaker of the first communication device, and suppressing audio received from the first communication device.

The mitigation module may be arranged in the first communication device, the second communication device, and/or may be arranged in a server, via which the real-time audio communication is routed.

Where the one or more measures comprise a notification to the first communication device requesting a user to take an action, the first and/or second communication devices may be configured to receive a request from the mitigation module and/or to display, to a user, the request, such as a request to mute a microphone of the first communication device, a request to mute a loudspeaker of the first communication device. In some embodiments, the first and/or second communication devices are configured, potentially by the detection module where this is arranged in the first and/or second communication devices, to transmit to the mitigation module a confirmation that the request has been provided to a user and/or a confirmation that the action has been taken by the user.

In some embodiments, the mitigation module is trained using a machine-learning algorithm.

It will be appreciated that the machine-learning algorithm may be implemented in any known manner. For instance, the mitigation module may be configured select one or more measures against acoustic feedback based on, whether feedback occurs or not and/or based on whether the feedback occurs as an audible echo or as a howling note, such as based on information about whether a current state of the communications system is stable, marginally stable, or unstable.

In some embodiments, the method further comprises: upon determining the state in the first communication device, determining, by means of the detection module, a playback volume of the first communication device based on hardware information in the first communication device; and determining, by means of the detection module, a microphone gain of the second communication device based on hardware information in the second communication device. Alternatively or additionally, the playback volume and/or the microphone gain may be determined in response to determining that the first device is in loudspeaker mode. In some embodiments, the playback volume of the first device is a playback volume of a loudspeaker, such as a built-in loudspeaker, of the first device. Alternatively or additionally, the microphone gain of the second device may be a microphone gain of a microphone, such as a built-in microphone, of the second device.

The playback volume and/or the hardware information of the first communication device and the microphone gain and/or the hardware information of the second communication device may be transmitted to the detection module, potentially arranged in a server, via which the real-time audio communication is routed. Alternatively or additionally, the playback volume of the first communication device may be determined by a first detection module, potentially arranged in the first communication device, and the microphone gain of the second communication device may be determined by a second detection module, potentially arranged in the second communication device.

In some embodiments, the distance threshold is based on the determined playback volume of the first communication device and the determined microphone gain of the second communication device.

For instance, where a playback volume of the first communication device and a microphone gain of the second communication device both are high, a high distance threshold may correspondingly be set. Hence, two communication devices arranged at a certain distance from each other may be considered as being in the same acoustic space, when the playback volume and microphone gain are high, whereas they may not be considered to be in the same acoustic space, if the playback volume and/or microphone gain is/are turned down.

In some embodiments, the method further comprises: determining that the playback volume of the first communication device is above a playback volume threshold, wherein the one or more measures against acoustic feedback, in response to determining that the playback volume is above the playback volume threshold include one or more of: sending a notification to the first communication device requesting the user to switch to headphone mode decreasing, by means of the mitigation module, the playback volume of the first communication device.

The notification may be displayed to a user by means of a display of the first communication device and/or may be communicated to user by means of one or more of an audio cue, haptic feedback and light indication.

In some embodiments, the playback volume threshold is determined based on the distance between the first communication device and the second communication device.

The playback volume threshold may be determined at least partly based on the distance between the first communication device and the second communication device. In some embodiments, the playback volume threshold may increase with the distance between the first communication device and the second communication device.

The playback volume threshold may be or form a mathematical function of the distance between the first communication device and the second communication device. The playback volume threshold may be proportional to the distance between the first communication device and the second communication device.

In some embodiments, the playback volume threshold, PlaybackVolume_{Th} may be expressed as:

$${PlaybackVolume}_{Th} = max ( 1 - \frac{distance}{{dist}_{Th}} , 0 )$$

where distance is the determined distance between the first and second communication device, and dist_{Th} is the distance threshold. The distance threshold may in an exemplary embodiment be approximately 5 metres. The PlaybackVolumeTh may be a factor of reduction of the maximum playback volume of the first communication device. For example, where the distance threshold is 5 metres and the estimated distance is 2 metres, PlaybackVolumeTh may be 0.6, indicating that the threshold volume is the maximum playback volume of the first communication device reduced by 60%, i.e. 40% of the maximum playback volume of the first communication device. If the determined distance gets larger than the distance threshold, i.e. where the relation between the determined distance and the distance threshold is above 1, PlaybackVolumeTh will be 0, thus indicating that the threshold volume is the maximum playback volume of the first communication device, i.e. the threshold volume is the maximum playback volume of the first communication device reduced by 0%.

In some embodiments, the playback volume threshold is determined based on a microphone gain of the second communication unit.

The playback volume threshold may be determined at least partly based on the microphone gain of the second communication device. In some embodiments, the playback volume threshold may decrease when the microphone gain of the second communication device is increased.

The playback volume threshold may be or form a mathematical function of the microphone gain of the second communication device. The playback volume threshold may be inversely proportional to the microphone gain of the second communication device.

In some embodiments, the method further comprises the step of: determining that a microphone gain of the second communication device is above a microphone gain threshold, wherein the one or more measures against acoustic feedback, in response to determining that the microphone gain is above the microphone gain threshold include: decreasing, by means of the mitigation module, the microphone gain of the second communication device.

The decrease of the microphone gain may be performed stepwise or by reducing the microphone gain by a predefined amount. Potentially, the microphone gain may be reduced to be at or below the microphone gain threshold. In some embodiments, a user of the second communication device is alerted that the microphone gain is reduced and/or may be prevented from increasing the gain for a predetermined time period after the gain decrease.

In some embodiments, the microphone gain threshold is determined based on the distance between the first communication device and the second communication device.

The microphone gain threshold may be a microphone gain threshold value. The microphone gain threshold may additionally or alternatively be determined at least partly based on the distance between the first communication device and the second communication device.

In some embodiments, the microphone gain threshold, MicrophoneGain_{Th} may be expressed as:

$${Microphonegain}_{Th} = max ( 1 - \frac{distance}{{dist}_{Th}} , 0 )$$

where distance is the determined distance between the first and second communication device, and dist_{Th} is the distance threshold. The distance threshold may in an exemplary embodiment be approximately 5 metres. The MicrophoneGain_{Th} may be a factor of reduction of the maximum microphone gain of the second communication device. For example, where the distance threshold is 5 metres and the estimated distance is 2 metres, MicrophoneGain_{Th} may be 0.6, indicating that the threshold microphone gain is the maximum microphone gain of the second communication device reduced by 60%, i.e. 40% of the maximum microphone gain of the second communication. If the determined distance gets larger than the distance threshold, i.e. where the relation between the determined distance and the distance threshold is above 1, MicrophoneGain_{Th} will be 0, thus indicating that the microphone gain threshold is the maximum microphone gain of the second communication device, i.e. the microphone gain threshold is the maximum microphone gain of the second communication device reduced by 0%.

In some embodiments, the microphone gain threshold is determined based on the playback volume of the second communication unit.

The microphone gain threshold may be determined at least partly based on the playback volume of the second communication unit.

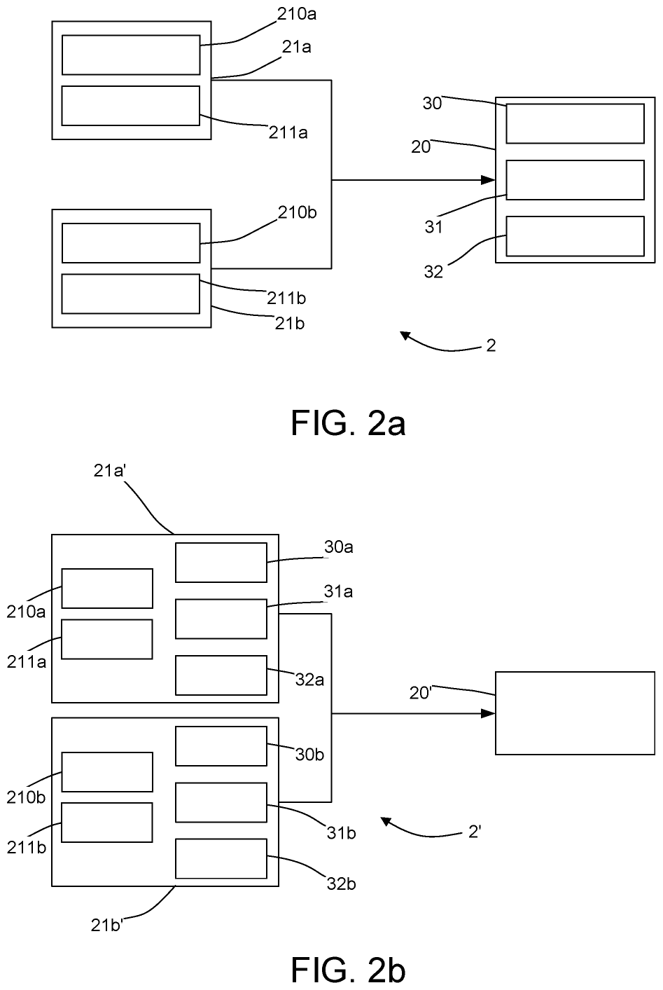

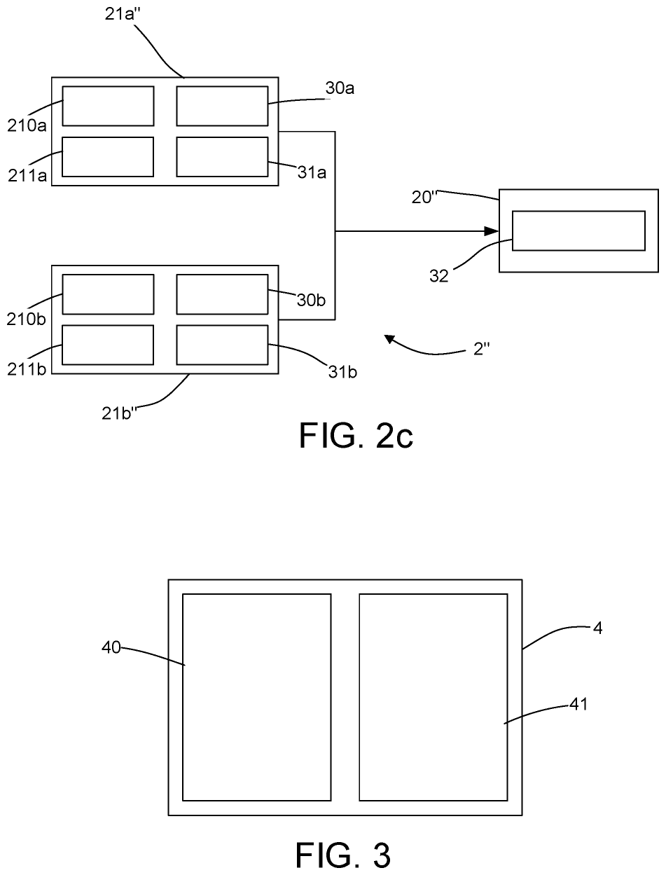

FIG. 2a shows a schematic block diagram of a first embodiment of a communications system 2 configured to perform a method according to the present disclosure.

The communications system 2 comprises a first communication device 21a and a second communication device 21b. The first communication device 21a is in real-time audio communication with the second communication device 21b. The real-time audio communication is routed via a server 20. The real-time audio communication may be any audio and/or video communication comprising real-time audio transmission, such as a point-to-point communication, e.g. Voice over Internet Protocol (VoIP) or software phone (softphone), or a peer-to-peer communication.

The first communication device 21a comprises a first audio interface 210a configured to record audio from and play back audio to a user of the first communication device 21a. Correspondingly, the second communication device 21b comprises a second audio interface 210b configured to record audio from and play back audio to a user of the second communication device 21b. It will be understood that in other embodiments, a recording interface and a playback interface may be provided alternatively or additionally to the respective audio interfaces 210a, 210b. The first 210a and second audio interfaces 210b may comprise an audio input device, such as a microphone, and an audio playback device, such as an audio processor, a headphone/speaker outlet, and/or one or more speakers.

The first communication device 21a further comprises a processor 211a. The processor 211a may be configured to monitor and register: a playback mode, such as a loudspeaker mode and a headphone mode, a playback level, and a microphone gain of the first audio interface 210a, as well as monitoring and registering sensor information (not shown in FIG. 2a) of the first communication device 21a. The processor 211a may furthermore be configured to monitor and register a microphone gain level of the second communication device 21a. Sensor information may be information from a wireless communication interface (not shown in FIG. 2a), such as a Bluetooth® and/or Wi-Fi module, of the first communication device 21a. The processor 211a may furthermore be configured to detect whether the first communication device is in real-time audio communication with the second communication device 21b.

Correspondingly, the second communication device 21b comprises a processor 211b. The processor 211b may be configured to monitor and register: a playback mode, such as a loudspeaker mode and a headphone mode, a playback level, and a microphone gain of the second audio interface 210b, as well as monitoring and registering sensor information (not shown in FIG. 2a) of the second communication device 21b. The processor 211b may furthermore be configured to monitor and register a microphone gain level of the second communication device 21b. Sensor information may be information from a wireless communication interface (not shown in FIG. 2a), such as a Bluetooth® and/or Wi-Fi module, of the second communication device 21b. The processor 211b may furthermore be configured to detect whether the second communication device is in real-time audio communication with the first communication device 21b.

Although the first 21a and second communication devices 21b are described as being similar, it will be appreciated that they may be different types of devices. For instance, each of the first 21a and second communication devices 21b may be a mobile phone, a tablet computer, a personal computer, a server, a personal digital assistant, or the like.

The server 20 comprises a detection module, comprising a feedback state detection module 30 and a feedback client detection module 31. The feedback state detection module 30 is configured to determine whether a need for one or more measures against acoustic feedback is present in the system 2. The feedback state detection module 30 may be configured to determine whether the first communication device 21a is in loudspeaker mode based on hardware information in the first communication device 21a, to determine whether the first communication device 21a is in real-time audio communications with the second communication device 21b based on connection information in the first communication device 21a, and to determine whether the first communication device 21a and the second communication device 21b are in a same acoustic space based on sensor information in the first communication device 21a. In some embodiments, the feedback state detection module 30 is configured to receive sensor information and information about one or more of a playback mode, a playback volume, sensor information, microphone gain, and/or any potential real-time audio communications from the first communication device 21a and/or from the second communication device 21b.

The feedback client detection module 31 may be configured to identify which of the communication devices 21a, 21b are causing acoustic feedback and/or are causing the system to be in a state, where feedback is likely to occur. The feedback client detection module 31 may be configured to identify such communication device 21a, 21b based on information from the client state detection module 30 and/or from the first 21a and/or second communication device 21b. In other embodiments, the client state detection module 30 may be configured to perform the functionality of the feedback client detection module 31.

The server 20 moreover comprises a mitigation module 32. The mitigation module may be configured to take measures against feedback, potentially upon request from the detection module, such as from one or more of the feedback state detection module 30 and feedback client detection module 31. The mitigation module 32 may be communicatively coupled to the detection module and/or to first communication device 21a and the second communication device 22. Further details and examples of measures against acoustic feedback are described with respect to the method 1.

FIG. 2b shows a schematic block diagram of a second embodiment of a communications system 2′ configured to perform a method according to the present disclosure.

The system 2′ comprises a first communication device 21a′, a second communication device 21b′ and a server 20′. Like the system 2 shown in FIG. 2a, the first communication device 21a′ is in real-time audio communication with the second communication device 21b′. The real-time audio communication is routed via a server 20′.

The first communication device 21a′ comprises a first audio interface 210a and a processor 211a as described with respect to the first communication device 21a shown in FIG. 2a. Correspondingly, the second communication device 21b′ comprises a second audio interface 210b and a processor 211b as described with respect to the second communication device 21b shown in FIG. 2a.

The first communication device 21a′ of system 2′, however, comprises a first detection module, comprising a first feedback state detection module 30a and a first feedback client detection module 31a, and a first mitigation module 32a. The first feedback state detection module 30a and the first feedback client detection module 31a may be and/or comprise similar features as described with respect to the feedback state detection module 30, feedback client detection module 31, and mitigation module 32, respectively, of the server 20 shown in FIG. 2a.

The second communication device 21b′ of system 2′, moreover, comprises a second detection module, comprising a second feedback state detection module 30b and a second feedback client detection module 31b, and a second mitigation module 32b. The second feedback state detection module 30b and the second feedback client detection module 31b may be and/or comprise similar features as described with respect to the feedback state detection module 30, feedback client detection module 31, and mitigation module 32, respectively, of the server 20 shown in FIG. 2a.

Each of the first 32a and second mitigation modules 32b may be configured to receive a request for measures against acoustic feedback from the first and second detection modules, respectively. Alternatively or additionally, each of the first 32a and second mitigation modules 32b may be configured to receive a request for measures against acoustic feedback from the second and first detection modules, respectively.

As shown in FIG. 2b, the server 20′ does not comprise any of the detection module and mitigation module. It will, however, be appreciated that, in some embodiments, the server as well as one or more of the first and second communication device may comprise a respective detection module and a mitigation module.

FIG. 2c shows a schematic block diagram of a third embodiment of a communications system 2″ configured to perform a method according to the present disclosure.

The communications system 2″ comprises a first communication device 21a″, a second communication device 21b″ and a server 20″. Like the systems 2, 2′ shown in FIGS. 2a and 2b, the first communication device 21a″ is in real-time audio communication with the second communication device 21b″. The real-time audio communication is routed via a server 20″.

The first communications device 21a″ comprises a first audio interface 210a and a processor 211a as described with respect to the first communication device 21a and 21a′ shown in FIGS. 2a and 2b, respectively. The first communication device 21a″ further comprises the first detection module, comprising the first feedback state detection module 30a and the first feedback client detection module 31a similar to the first communication device 21a′. Correspondingly, the second communications device 21b″ comprises the second audio interface 210b and the processor 211b as described with respect to the second communication device 21b and 21b′ shown in FIGS. 2a and 2b, respectively. The second communication device 21b″ further comprises the second detection module, comprising the second feedback state detection module 30b and the second feedback client detection module 31b similar to the second communication device 21b′.

In the system 2″, the server 20″, however, comprises the mitigation module 32 as described with respect to the system 2 shown in FIG. 2a. Thereby, a central mitigation module 32 may be provided, potentially configured to be in communication with the respective mitigation modules of the first 21a″ and second communication devices 21b″. The mitigation module 32 may, thus, be configured to receive a request for measures against acoustic feedback from the first 21a″ and/or the second communication device 21b″.

The communications systems 2, 2′, 2″ are configured to perform the method 1. Features of the communications system 2, 2′, 2″ will exemplarily be further described in light of the method 1. It will, however, be appreciated that the method 1 may be performed by systems different from the exemplary embodiments of the communication systems shown in FIGS. 2a-2c.

FIG. 3 shows a schematic block diagram of a communication device 4 comprising circuitry configured to perform a method according to the present disclosure.

The communication device 4 comprises an audio interface 40 and a processor 41. The audio interface is configured to record audio from and play back audio to a user of the first communication device 4. In other embodiments, a recording interface and a playback interface may be provided alternatively or additionally to the audio interface 40. The audio interfaces 40 may comprise an audio input device, such as a microphone, and an audio playback device, such as an audio processor, a headphone/speaker outlet, and/or one or more speakers. The communication device 4 may comprise a wireless communication interface (not shown) for wireless communication, such as Bluetooth® or Wi-Fi wireless communication interface.

The communication device 4 moreover comprises a processor 41. The processor 41 may be configured to monitor and register: a playback mode, such as a loudspeaker mode and a headphone mode, a playback level, and a microphone gain of the audio interface 40, as well as monitoring and registering sensor information (not shown in FIG. 3) of the communication device 4. The processor 41 may furthermore be configured to monitor and register a microphone gain level of a communication device with which the communication device is in real-time audio communication. Sensor information may be information from a wireless communication interface (not shown in FIG. 2a), such as a Bluetooth® and/or Wi-Fi module, of the communication device 4. The processor 211a may furthermore be configured to detect whether the communication device 4 is in real-time audio communication with a second communication device.

The communication device 4 may furthermore comprise one or more of a detection module, potentially comprising a feedback state detection module and a feedback client detection module, and a mitigation module. The functionality of any one or more thereof may be provided by the processor 41. A detection module and/or a mitigation, where such are provided in the communication device 4, may be as described with respect to the method 1 and or to the systems 2, 2′, or 2″.

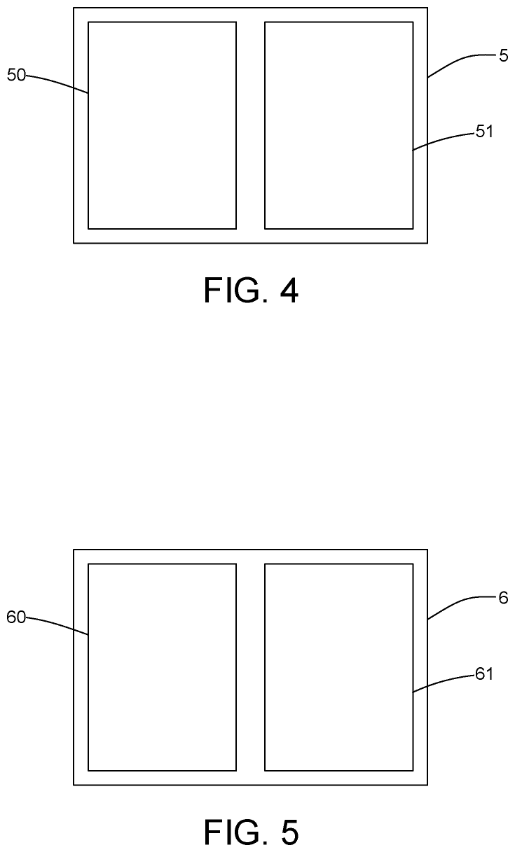

FIG. 4 shows a schematic block diagram of an encoder 5 according to the present disclosure.

The encoder 5 comprises a memory 50 for storing instructions and a processor 51 for performing instructions. The encoder 5 is configured to encode an audio signal and include, in the encoded audio signal, metadata indicating whether there is a need for one or more measures against acoustic feedback.

The encoder 5 may receive an indication whether the metadata should be included in the encoded audio signal from a detection module. The detection module may be a detection module as described with respect to any of FIG. 2a-2c or 3.

The encoder 5 may be arranged at a first communication device, the first communication device being configured to be in real-time audio communication with a second communication device.

The encoder 5 may be configured to encode the audio according to any known audio codec and to include metadata indicating whether there is a need for one or more measures against acoustic feedback.

The encoder 5 may be configured to receive an indication from a detection module, such as a detection module as described with respect to any of FIGS. 2a, 2b, and 2c. The encoder 5 may be configured to include such an indication in the metadata.

FIG. 5 shows a schematic block diagram of a decoder 6 according to the present disclosure.

The decoder 6 comprises a memory 60 for storing instructions and a processor 61 for performing instructions. The decoder is configured to decode an encoded audio signal; and extract, from the decoded audio signal, metadata indicating whether there is a need for measures against acoustic feedback.

The decoder 6 may be arranged at a second communication device, the second communication device being configured to be in real-time audio communication with a second communication device. Alternatively or additionally, the decoder may be arranged in a server, such as a server 20, 20′, 20″ as described with respect to any of FIGS. 2a, 2b, and 2c.

The decoder 6 may be configured to decode the audio according to any known audio codec, and to extract metadata indicating whether there is a need for one or more measures against acoustic feedback. In some embodiments, the decoder 6 may be configured to transmit the metadata indicating whether there is a need for one or more measures against acoustic feedback to a mitigation module for taking measures against acoustic feedback. The mitigation module may be a mitigation module 32, 3a, 32b as described with respect to FIGS. 2a, 2b, and 2c.

### Final Remarks

As used herein, unless otherwise specified the use of the ordinal adjectives “first”, “second”, “third”, etc., to describe a common object, merely indicate that different instances of like objects are being referred to, and are not intended to imply that the objects so described must be in a given sequence, either temporally, spatially, in ranking, or in any other manner.

In the claims below and the description herein, any one of the terms comprising, comprised of or which comprises is an open term that means including at least the elements/features that follow, but not excluding others. Thus, the term comprising, when used in the claims, should not be interpreted as being limitative to the means or elements or steps listed thereafter. For example, the scope of the expression a device comprising A and B should not be limited to devices consisting only of elements A and B. Any one of the terms including or which includes or that includes as used herein is also an open term that also means including at least the elements/features that follow the term, but not excluding others. Thus, including is synonymous with and means comprising.

As used herein, the term “exemplary” is used in the sense of providing examples, as opposed to indicating quality. That is, an “exemplary embodiment” is an embodiment provided as an example, as opposed to necessarily being an embodiment of exemplary quality.

It should be appreciated that in the above description of exemplary embodiments of the invention, various features are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that more features are required than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

Furthermore, while some embodiments described herein include some but not other features included in other embodiments, combinations of features of different embodiments are meant to be encompassed, and form different embodiments, as would be understood by those skilled in the art. For example, in the following claims, any of the claimed embodiments can be used in any combination.

Furthermore, some of the embodiments are described herein as a method or combination of elements of a method that can be implemented by a processor of a computer system or by other means of carrying out the function. Thus, a processor with the necessary instructions for carrying out such a method or element of a method forms a means for carrying out the method or element of a method. Furthermore, an element described herein of an apparatus embodiment is an example of a means for carrying out the function performed by the element.

In the description provided herein, numerous specific details are set forth. However, it is understood that embodiments of the invention may be practiced without these specific details. In other instances, well-known methods, structures and techniques have not been shown in detail in order not to obscure an understanding of this description.

Thus, while there has been described specific embodiments of the invention, those skilled in the art will recognize that other and further modifications may be made, and it is intended to claim all such changes and modifications. For example, any formulas given above are merely representative of procedures that may be used. Functionality may be added or deleted from the block diagrams and operations may be interchanged among functional blocks. Steps may be added or deleted to methods described.

Systems, devices and methods disclosed hereinabove may be implemented as software, firmware, hardware or a combination thereof. For example, aspects of the present application may be embodied, at least in part, in a device, a system that includes more than one device, a method, a computer program product, etc. In a hardware implementation, the division of tasks between functional units referred to in the above description does not necessarily correspond to the division into physical units; to the contrary, one physical component may have multiple functionalities, and one task may be carried out by several physical components in cooperation. Certain components or all components may be implemented as software executed by a digital signal processor or microprocessor or be implemented as hardware or as an application-specific integrated circuit. Such software may be distributed on computer readable media, which may comprise computer storage media (or non-transitory media) and communication media (or transitory media). As is well known to a person skilled in the art, the term computer storage media includes both volatile and non-volatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information, and which can be accessed by a computer. Further, it is well known to the skilled person that communication media typically embodies computer readable instructions, data structures, program modules or other data in a modulated data signal such as a carrier wave or other transport mechanism and includes any information delivery media.

Various aspects of the present invention may be appreciated from the following enumerated example embodiments (EEEs):
EEE1. A method for managing acoustic feedback in real-time audio communications in a communications system, the method comprising:
   determining, by means of a detection module, whether a first communication device is in loudspeaker mode based on hardware information in the first communication device;
   determining, by means of the detection module, whether the first communication device is in real-time audio communications with a second communication device based on connection information in the first communication device;
   determining, by means of the detection module, whether the first communication device and the second communication device are in a same acoustic space based on sensor information in the first communication device;
   upon determining by means of the detection module that:
      the first communication device is in loudspeaker mode,
      the first communication device is in real-time audio communications with the second communication device, and
      the first communication device and the second communication device are in the same acoustic space,
   providing, to a mitigation module, a request signal for requesting one or more measures against acoustic feedback.
EEE2. The method according to EEE1, comprising:
   upon determining by means of the detection module that:
      the first communication device is in loudspeaker mode,
      the first communication device is in real-time audio communications with the second communication device, and
      the first communication device and the second communication device are in the same acoustic space,
   determining, by means of the detection module, a state in the first communication device indicating a need for measures against acoustic feedback.
EEE3. The method according to EEE 1 or 2, further comprising:
   providing, by the mitigation module, one or more measures against acoustic feedback in response to receiving, at the mitigation module, the request signal.
EEE4. The method according to any one of the preceding EEEs, wherein the one or more measures against acoustic feedback include one or more of:
   decreasing, by means of the mitigation module, a playback volume of the first communication device,
   decreasing, by means of the mitigation module, a microphone gain of the second communication device,
   sending a notification to the first communication device requesting a user to switch to headphone mode,
   sending a notification to the first communication device requesting the user to mute a microphone of the first communication device,
   sending a notification to the first communication device requesting the user to mute a loudspeaker of the first communication device, and
   suppressing audio received from the first communication device.
EEE5. The method according to any one of the preceding EEEs, further comprising:
   determining, by means of the detection module, a distance between the first communication device and the second communication device based on sensor information in the first communication device,
   wherein the first communication device and the second communication device are determined to be in the same acoustic space if the distance between the first communication device and the second communication device is less than a distance threshold.
EEE6. The method according to EEE 2, further comprising:
   upon determining the state in the first communication device,
   determining, by means of the detection module, a playback volume of the first communication device based on hardware information in the first communication device; and
   determining, by means of the detection module, a microphone gain of the second communication device based on hardware information in the second communication device.
EEE7. The method according to EEE 6, wherein the distance threshold is based on the determined playback volume of the first communication device and the determined microphone gain of the second communication device.
EEE8. The method according to any one of the preceding EEEs, wherein the method further comprises:
   determining that the playback volume of the first communication device is above a playback volume threshold,
   wherein the one or more measures against acoustic feedback, in response to determining that the playback volume is above the playback volume threshold include one or more of:
      sending a notification to the first communication device requesting the user to switch to headphone mode
      decreasing, by means of the mitigation module, the playback volume of the first communication device.
EEE9. The method according to EEE 8, wherein the playback volume threshold is determined based on one or more of the distance between the first communication device and the second communication device, and a microphone gain of the second communication unit.
EEE10. The method according to any one of the preceding EEEs, wherein the method further comprises:
   determining that a microphone gain of the second communication device is above a microphone gain threshold,
   wherein the one or more measures against acoustic feedback, in response to determining that the microphone gain is above the microphone gain threshold include
      decreasing, by means of the mitigation module, the microphone gain of the second communication device.
EEE11. The method according to EEE 10, wherein the microphone gain threshold is determined based on one or more of the distance between the first communication device and the second communication device and the playback volume of the second communication unit.
EEE12. The method according to any one of the preceding EEEs, wherein the sensor information of the first device is based on a wireless communication interface of the first device.
EEE13. The method according to any one of the preceding EEEs, wherein one or more of the detection module and the mitigation module is provided in the first device.
EEE14. The method according to any one of the preceding EEEs, wherein the communications system comprises the first client, the second client, and a communications server, wherein one or more of the detection module and the mitigation module is provided in the communications server.
EEE15. The method according to any one of the preceding EEEs, wherein the mitigation module is trained using a machine-learning algorithm.
EEE16. A communication device comprising circuitry configured to perform the method according to any one of the previous EEEs.
EEE17. A communications system comprising a first communication device, a second communication device, a detection module, and a mitigation module, the system being configured to perform the method according to any one of EEEs 1 to 15.
EEE18. A non-transitory computer-readable storage medium comprising instructions which, when executed by a device having processing capability, causes the device to carry out the method of any one of EEEs 1 to 15.
EEE19. An encoder configured to:
   encode an audio signal; and
   include, in the encoded audio signal, metadata indicating whether there is a need for one or more measures against acoustic feedback.
EEE20. A decoder configured to:
   decode an encoded audio signal; and
   extract, from the decoded audio signal, metadata indicating whether there is a need for measures against acoustic feedback.

1. A method for managing acoustic feedback in real-time audio communications in a communications system, the method comprising:
determining, by means of a detection module, whether a first communication device is in loudspeaker mode based on hardware information in the first communication device;
determining, by means of the detection module, whether the first communication device is in real-time audio communications with a second communication device based on connection information in the first communication device;
determining, by means of the detection module, whether the first communication device and the second communication device are in a same acoustic space based on sensor information in the first communication device;
upon determining by means of the detection module that:
the first communication device is in loudspeaker mode,
the first communication device is in real-time audio communications with the second communication device, and
the first communication device and the second communication device are in the same acoustic space,
providing, to a mitigation module, a request signal for requesting one or more measures against acoustic feedback.

2. The method according to claim 1, further comprising:
providing, by the mitigation module, one or more measures against acoustic feedback in response to receiving, at the mitigation module, the request signal.

3. The method according to claim 1, wherein the one or more measures against acoustic feedback include one or more of:
decreasing, by means of the mitigation module, a playback volume of the first communication device,
decreasing, by means of the mitigation module, a microphone gain of the second communication device,
sending a notification to the first communication device requesting a user to switch to headphone mode,
sending a notification to the first communication device requesting the user to mute a microphone of the first communication device,
sending a notification to the first communication device requesting the user to mute a loudspeaker of the first communication device, and
suppressing audio received from the first communication device.

4. The method according to claim 1, further comprising:
determining, by means of the detection module, a distance between the first communication device and the second communication device based on sensor information in the first communication device,
wherein the first communication device and the second communication device are determined to be in the same acoustic space if the distance between the first communication device and the second communication device is less than a distance threshold.

5. The method according to claim 4, further comprising:
determining, by means of the detection module, a playback volume of the first communication device based on hardware information in the first communication device; and
determining, by means of the detection module, a microphone gain of the second communication device based on hardware information in the second communication device,
wherein the distance threshold is based on the determined playback volume of the first communication device and the determined microphone gain of the second communication device.

6. The method according to claim 1, wherein the method further comprises:
determining that the playback volume of the first communication device is above a playback volume threshold,
wherein the one or more measures against acoustic feedback, in response to determining that the playback volume is above the playback volume threshold include one or more of:
sending a notification to the first communication device requesting the user to switch to headphone mode decreasing, by means of the mitigation module, the playback volume of the first communication device,
wherein the playback volume threshold is determined based on one or more of the distance between the first communication device and the second communication device, and a microphone gain of the second communication unit.

7. The method according to claim 1, wherein the method further comprises:
determining that a microphone gain of the second communication device is above a microphone gain threshold,
wherein the one or more measures against acoustic feedback, in response to determining that the microphone gain is above the microphone gain threshold include decreasing, by means of the mitigation module, the microphone gain of the second communication device,
wherein the microphone gain threshold is determined based on one or more of the distance between the first communication device and the second communication device and the playback volume of the second communication unit.

8. The method according to claim 1, wherein the sensor information of the first device is based on a non-acoustic sensor of the first communication device.

9. The method according to claim 8, wherein the sensor information of the first device is based on a wireless communication interface of the first device.

10. The method according to claim 1, wherein one or more of the detection module and the mitigation module is provided in the first device or, wherein the communications system comprises the first client, the second client, and a communications server, wherein one or more of the detection module and the mitigation module is provided in the communications server.

11. The method according to claim 1, wherein the first communication device comprises built-in loudspeakers and wherein the second communication device comprises a built-in microphone.

12. A communication device comprising circuitry configured to perform the method according to claim 1.

13. A communications system comprising a first communication device, a second communication device, a detection module, and a mitigation module, the system being configured to perform the method according to claim 1.

14. A non-transitory computer-readable storage medium comprising instructions which, when executed by a device having processing capability, causes the device to carry out the method of claim 1.

15. An encoder configured to:
encode an audio signal; and
include, in the encoded audio signal, metadata indicating whether there is a need for one or more measures against acoustic feedback.

16. A decoder configured to:
decode an encoded audio signal; and
extract, from the decoded audio signal, metadata indicating whether there is a need for measures against acoustic feedback.

17. The method according to claim 5, wherein the distance threshold is based on the determined playback volume of the first communication device and the determined microphone gain of the second communication device.

18. The method according to claim 6, wherein the playback volume threshold is determined based on one or more of the distance between the first communication device and the second communication device, and a microphone gain of the second communication unit.

19. The method according to claim 7, wherein the microphone gain threshold is determined based on one or more of the distance between the first communication device and the second communication device and the playback volume of the second communication unit

20. The method of claim 1, wherein the mitigation module is trained using a machine learning algorithm.
